(19) United States
(12) Patent Application Publication
(10) Pub. No.: US 2020/0086505 A1
(43) Pub. Date: Mar. 19, 2020

(54) SUCTION DEVICE

(71) Applicant: SHENZHEN ULMT TECHNOLOGY CO., LTD, Shenzhen, Guangdong (CN)

(72) Inventor: Linhong NIE, Shenzhen, Guangdong (CN)

(21) Appl. No.: 15/750,586

(22) PCT Filed: Oct. 9, 2016
(86) PCT No.: PCT/CN2016/102572

§ 371 Date: Feb. 6, 2018

(51) Int. Cl. B25J 15/06

(52) U.S. Cl. CPC B25J 15/0616

(57) ABSTRACT

Disclosed is a suction device that includes: a main body, a suction nozzle, and an elastic member. A through passage is defined in the main body. One end of the main body is defined as a suction nozzle mounting end. The part of the through passage at the suction nozzle mounting end is defined as an inner cavity. The suction nozzle is movably installed within the inner cavity and connected to the main body and communicated with the passage. The elastic member is disposed within the inner cavity and is operative to provide a pushing force for moving the suction nozzle outward of the inner cavity. The suction device can suck up a product having a convex or concave surface in an effective and smooth manner; meanwhile the deviation resulting from misalignment of the product can be corrected facilitating precise positioning of the product in the production line.

### RELATED APPLICATIONS

The present application is a National Phase of International Application Number PCT/CN2016/102572, filed Oct. 19, 2016.

### TECHNICAL FIELD

This disclosure relates to suction devices, and more particularly relates to a suction device for picking up a product having a curved surface, which belongs to the field of manufacture of clamping tools.

### BACKGROUND

In production lines or R & D testing laboratories, mechanical arms and other clamping tools are often used to, e.g., pick up, hold, and transfer a product to a designated position for processing or assembling purposes. For thin products such as a cell phone rear housing, a watch display dial or other components or parts, the product may be easily deformed when gripped by a clamping tool such as a mechanical arm due to the thin housing of the product. Although the operator has enhanced the control over the gripping force of the mechanical arm, the damage to the product caused by improper operation of the mechanical arm cannot be suppressed.

In this regard, those having skill in the art use suction cups instead to pick up and transfer thin products by suction. A typical suction cup includes a cylindrical body and a suction nozzle. A through gas passage is defined in the cylindrical body. The suction nozzle is a disk- or bowl-shaped rubber product and is fixed on one end of the cylindrical body. The other end of the cylindrical body is connected to an air pipe of a vacuum system. The product can have a flat surface and a side view of such a product is depicted in FIG. 1A. To suck up the product using a suction cup, the suction cup is moved to make the suction nozzle contact the product, and then the vacuum system draws air from within the suction cup via the air pipe so that the pressure inside the suction nozzle decreases and the product would stick to the suction nozzle. The pressure inside the suction nozzle is maintained or further reduced so that the product would stably stick to the suction cup. As such, the suction cup is further manipulated to pick up and transfer the product and perform additional operations.

However, for a product having a protrusion on its suction surface—a side view of such a product is depicted in FIG. 1B in which the surface of the suction area has a convex profile—typically the suction nozzle needs to be attached to the protrusion to facilitate the operation. But in picking up such a product using an existing suction nozzle, the original position of the product before it is sucked up would often deviate. This is because there is a certain gap between the positioning tool for fixing the product and the product itself. In particular, when the positioning tool has been used for a period of time and so wears to a certain degree, the gap will inevitably increase resulting in a shift in the position of the product. The suction area where the suction nozzle of the suction cup contacts the product will also deviate such that he deviating suction area straddles the region on the product surface where the profile changes abruptly leading to untight contact between the suction cup and the suction surface. Consequently, air leaks from the suction cup and the suction cup is unable to suck up the product or the product may slide after being sucked up. In some extreme cases, the displacement may continue to increase before the product slips off. Other pickup failures also are possible. Once the product cannot be sucked up or the product slides or slips off, manual intervention is required to troubleshoot the fault, causing the production line to suspend production—hence delay of production and reduced production efficiency. The product that slips off may also be damaged.

### SUMMARY

It is therefore one object of this disclosure to provide a suction device capable of efficiently and smoothly sucking up a product having a surface with a convex or concave profile.

The following solution is adopted for the above-mentioned object.

A suction device is provided and includes a main body, a suction nozzle, and an elastic member. A through passage is defined in the main body. One end of the main body is defined as a suction nozzle mounting end. The part of the passage at the suction nozzle mounting end is defined as an inner cavity. The suction nozzle is movably installed in the inner cavity and connected to the main body. The suction nozzle is in communication with the passage. The elastic member is disposed within the inner cavity and is operative to provide a pushing force for moving the suction nozzle outward of the inner cavity.

In production lines, the suction device in accordance with this disclosure can be manipulated by mechanical arms. The suction device can be moved to the suction position on the product to be sucked up, where the suction position can be a convex or concave surface. If the initial position in which the product is placed deviates, then the suction position (hereinafter referred to as suction area A) on the product where suction by the suction device takes place will also be deviate accordingly. As a result, the end surface of the suction nozzle mounting end of the main body would be in asymmetrical contact with the curved surface; that is, a part of the end surface contacts the raised edge of the curved surface, while the other part is not in contact with the raised edge. When the suction nozzle mounting end keeps approaching the product, the end surface of the suction nozzle mounting end creates a lateral force that is acted on the raised edge, so that during the suction process the product moves towards the correct suction position under the action of the lateral force. Meanwhile, the suction nozzle moves within the inner cavity of the suction nozzle mounting end preventing the suction nozzle from blocking the movement of the suction nozzle mounting end approaching the product. Furthermore, by the elastic member, the suction nozzle and the protrusion can be kept in full contact. Therefore, the suction device provided by this disclosure not only can suck up the products having a curved surface, but it can correct the suction position on the product so that the product having a surface of a curved profile can be sucked up in an effective and smooth manner.

In some embodiments, the suction nozzle is connected to the main body via a connecting unit. The connecting unit includes a columnar stop pin and a movable block which is a hollow barrel. A closed groove is defined in a side wall of the movable block. The movable block is fixed to the suction nozzle and disposed between the suction nozzle and the elastic member. The movable block is in clearance fit with an inner wall of the inner cavity and so is operative to move along with the suction nozzle within the inner cavity. A through hole corresponding to the closed groove is defined in the side wall of the main body, and the stop pin is inserted through the through hole into the closed groove. Thus, when the movable block moves within the inner cavity, the stop pin is operative to move accordingly within the closed groove preventing the suction nozzle from detaching from the main body.

By the cooperation between the stop pin and the closed groove, the suction nozzle and the movable block as a whole are operative to move inside the inner cavity of the main body within the length of the closed groove.

In accordance with the disclosure, for curved surfaces having different raised heights, the elastic member with the suitable strength and suitable original length can be determined by calculation, and a closed groove of suitable length can also be determined, so that the range of movement of the suction nozzle can be determined.

To ensure smooth movement of the suction nozzle within the inner cavity of the main body, one closed groove and one corresponding through hole constitute one connective set. Two to three connective sets are arranged at equal distances along the circumference of a cross section of the main body. Herein, the main body is not limited to a cylindrical body. By “circumference”, it means the axis of the passage is taken as the center and the connective sets are distributed at equal angular intervals on the plane of the cross-section of the main body. As an example, three connective units are arranged; the axis of the passage is taken as the center and the three connective units are arranged at intervals of 120 degrees.

The suction device further includes an air reservoir which is constituted by a part of the passage located between the air inlet end and the inner cavity of the passage, the air reservoir having a diameter greater than that of the passage. As compared to a suction device without an air reservoir, when attached to the same vacuum system, the air reservoir can provide sufficient air to extend the time required by the suction process from the suction nozzle contacting the product to the product being sucked up, and so sufficient time is allowed for product corrections.

In some embodiments, the suction nozzle includes a nozzle body and a soft rubber part. The suction nozzle defines a semi-open cavity having an open end facing the outside of the main body. A hole is defined in the nozzle body to communicate the semi-open cavity with the passage. The soft rubber part is fixed at the open end of the nozzle body, and is made of at least one selected from the group consisting of silicone, silicone rubber, polyurethane, nitrile rubber, and a vinyl-containing polymer. In accordance with this disclosure, the material of the soft rubber part can be selected depending on the product to be sucked up in the examples raised above. Compared with existing rubber suction nozzles, the soft rubber part according to this disclosure enhances the anti-wear ability, reduces the frequency of production halt and replacement, improves the production efficiency, avoids the generation of a large amount of discarded rubber, and saves energy and protects the environment. In addition, the material of the soft rubber part of the disclosure is softer and so can provide greater amounts of deformation under the same suction force thus providing better sealing effect in relation to the product, and can also reduce the occurrence of product slippage in the face of suction surfaces with a curved profile.

In some embodiments, the soft rubber part has a congruent design with the profile of the suction surface of the product to be sucked up. Thus, the suction nozzle can more closely contact and be sealed in relation with the product, hence better suction effects.

In some embodiments, to suck up a product having a concave surface or a partial concave surface, the suction nozzle protrudes from the suction nozzle mounting end of the main body under a natural state without negative pressure. While regarding some products having a convex surface, for example, the suction nozzle retracts into the suction nozzle mounting end of the main body under the natural state without negative pressure.

The elastic member is a component that is scalable when subjected to a force. A common choice for the elastic member can be a polyurethane block. A through hole is defined in the center of the polyurethane block to communicate the suction nozzle with the passage facilitating the normal operation of the suction nozzle.

As another implementation, the elastic member can also be chosen as a common compression spring such that the hollow part at the center of the spring can communicate the hole of the nozzle body with the passage, ensuring the normal operation of the suction nozzle.

In some embodiments, in order that the elastic member still settles in its working position under the natural state free of negative pressure, a first boss is arranged on the contact surface between the movable block and the compression spring. The first boss extends into the center of the compression spring preventing dislocation of the compression spring.

Based on the same concept, in some embodiments a second boss is also disposed on the abutment surface between the compression spring and the main body. The second boss extends into the center of the compression spring to prevent dislocation of the compression spring.

In some embodiments, both the first boss and the second boss are arranged.

In some embodiments, the end surface of the suction nozzle mounting end of the main body lies in the same plane. Since the end surface of the suction nozzle mounting end is flat, no congruent design is applied. Thus, after the product is sucked up, the surface around the suction surface of the product would fully stick with the end surface of the suction nozzle mounting end. When the suction device of the present disclosure is vertically disposed, the upper surface of the product can be kept horizontal, and the product is in a state of being smoothly sucked up, so that the unstable suction and falling off of the product can be avoided.

In some other embodiments, for products having a larger distribution of curved surface that extends beyond the suction area, the soft rubber part adopts a congruent design with the profile of the suction surface of the product to be sucked up. In addition, the end surface of the suction nozzle mounting end of the main body may also adopt a congruent design with the profile surrounding the suction surface of the product to be sucked up. By the close matching of the congruent surface of the suction nozzle and/or the suction nozzle mounting end of the main body with the product, the suction device and the product can be better sealed in relation to each other, further facilitating the smooth suction of the product.

In accordance with this disclosure, the suction device can suck up a product having a curved surface in an effective and smooth manner, and can also finely adjust the position of the product so as to correct the deviation resulting from misalignment of the product, leading to accurate positioning of the product in the production line with high repeatable positioning precision. In addition, with the congruent design of the soft rubber part and/or the end surface of the suction nozzle mounting end of the main body, the suction device of the disclosure would not only be able to suck up products having a suction surface with any irregular profile, but it is able to suck up products having a flat surface in a smooth fashion, hence wider scope of application of the suction nozzle. In another respect, the suction nozzle is coated with a soft rubber which provides a soft contact with the product surface, so no damage would be done to the product enabling longer service life of the suction nozzle. Further advantages of the suction device include: usability as an integral component and ease of installation; detachability and ease of repair and replacement of wearing parts. The air-reservoir-type cavity design also allows the suction device sufficient time to correct for deviations during the suction process.

### BRIEF DESCRIPTION OF THE ACCOMPANYING DRAWINGS

FIG. 1 shows schematic side views of products, wherein FIG. 1A is a schematic diagram of a product having a flat surface, FIG. 1B is a schematic diagram of a product having on its surface a protrusion with a flat top, and FIG. 1C is a schematic diagram of a product having on its surface a protrusion with a curved top.

FIG. 2 is a schematic cross-sectional view of a suction device in a negative-pressure-free state in accordance with the disclosure.

FIG. 3 is a schematic cross-sectional view of a suction device in a negative pressure state in accordance with the disclosure.

### DETAILED DESCRIPTION OF ILLUSTRATIVE EMBODIMENTS

A suction device capable of smoothly sucking up a product having a curved surface on its suction surface is disclosed.

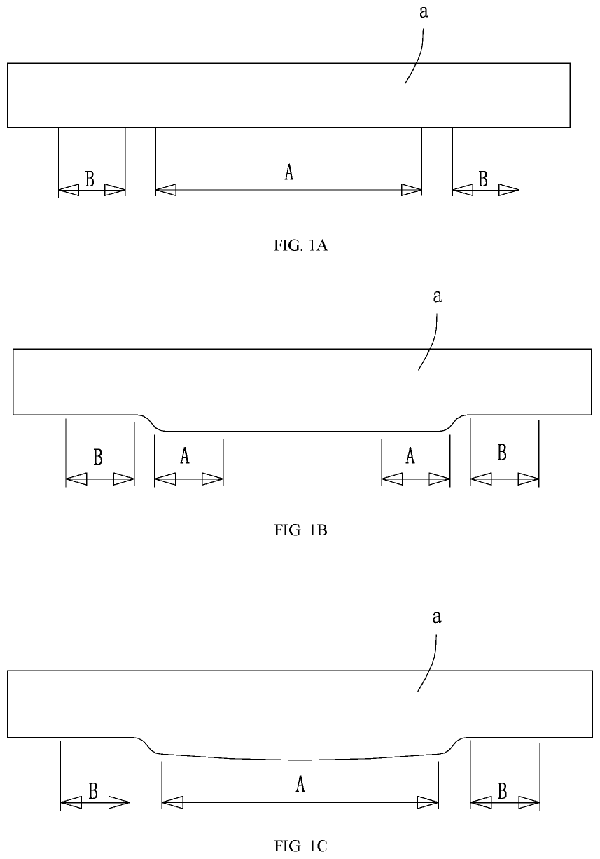

Products to be sucked up can be found in a variety of forms. There are products with a flat suction surface, e.g., a common rear housing of a mobile phone. There are also products with a cambered or raised suction surface, e.g., sheet metal parts found of an automotive, watch dials, and so on. A planar-type product and products having protrusions are shown in FIGS. 1A to 1C. In these drawings, the area A is the contact area between the suction nozzle and the product, and is referred to as the suction area for short, while the area B is an abutment area in contact with the end surface of the suction nozzle mounting end according to this disclosure. In the present disclosure, the products that can be sucked up are not limited to those having a flat surface. Note, the products shown in FIGS. 1A to 1C are intended for illustration purposes only—the curved surface can also be a recess, for example. In some embodiments, the area B can also be an undulating curved surface.

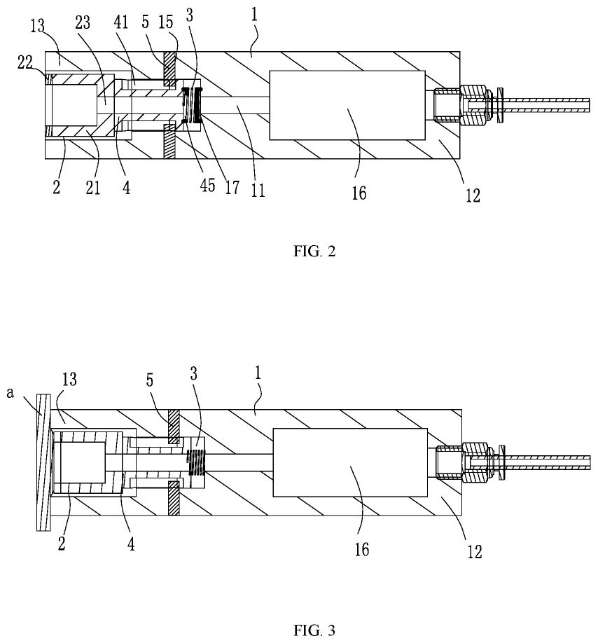

When a deviation occurs to the setting position of a product having a curved surface in the production line (see the product portrayed in FIG. 1B or 1C having a convex surface as an example), in order to suck up such a product with a deviating position smoothly and efficiently, a suction device is provided herein that includes a main body 1, a suction nozzle 2, and an elastic member 3, as illustrated in FIG. 2. A through passage is defined in the main body 1. One end of the main body is defined as a suction nozzle mounting end 13 while the other end is defined as an air outlet end that is connected to a vacuum system. For illustration purposes, the part of the passage located at the suction nozzle mounting end 13 is defined as an inner cavity. The main body 1 may be cylindrical or prismatic, but the shape of the main body 1 won't be particularly limited therein. The suction nozzle 2 is movably installed within the inner cavity and connected to the main body 1. The suction nozzle 2 is in communication with the air passage 11. The elastic member 3 is disposed within the inner cavity to provide the pushing force for moving the suction nozzle outside the inner cavity.

The inner cavity defined in the suction nozzle mounting end 13 refers to a blind hole made by drilling or the like in the end surface of the suction nozzle mounting end 13. The blind hole is then communicated with the air passage on the suction end thus forming a passage that runs through the main body. The suction nozzle 2 is installed and accommodated within the cavity, and is also in communication with the air passage 11 so that the suction nozzle 2 can be provided with sufficient suction force in sucking up products. Various modes of communication are possible between the suction nozzle 2 and the air passage 11, and those skilled in the art can determine the communication mode between the suction nozzle 2 and the air passage 11 based on experience and on-site requirements. For example, the suction nozzle 2 can be connected to the air passage 11 via an elastic hose. Or, the communication between the suction nozzle 2 and the air passage 11 can be achieved through a movable block, which will be described in further detail in the following description.

In sucking up a product with a convex profile using the suction device provided by this disclosure, the suction device is moved to a position substantially aligned with the raised portion of the product, and is then gradually brought close to the product by using a mechanical arm. During this process, the end of the suction nozzle mounting end 13 adjusts the product to a proper position while the suction nozzle moves inwardly of the inner cavity of the suction nozzle mounting end 13 under the stress exerted by the raised portion. The suction nozzle then compresses the elastic member until the end surface of the suction nozzle mounting end of the main body contacts and abuts against the surface of the product surrounding the suction surface, preventing the product and the suction nozzle from keeping retracting. At this point, the suction device creates a sufficient degree of vacuum inside the suction nozzle through the use of the vacuum system, so as to provide a sufficient suction force for sucking up the product. Therefore, the product can be smoothly transferred and the occurrence of product slippage can be avoided.

Hereinafter, some illustrative embodiments in accordance with this disclosure will be described in greater detail.

FIG. 2 illustrates the structure of a suction device in accordance with this disclosure. As illustrated in FIG. 2, the suction device in accordance with the disclosure includes a main body 1, a suction nozzle 2, and an elastic member 3. An air passage 11 that runs through the main body 1 is defined in the main body 1. For ease of description, one end of the air passage is referred to as an air outlet end 12 that is connected to a vacuum system of the production line through an air pipe joint. Opposite to the air outlet end is the suction nozzle mounting end 13. The inner diameter of the suction nozzle mounting end is greater than that of the air passage, and a step is formed at the connection between the suction nozzle mounting end and the passage. The suction nozzle 2 is disposed within the inner cavity at the suction nozzle mounting end and connected to the main body 1 so as to prevent the suction nozzle from leaving the main body when the suction device is vertically oriented.

The suction nozzle can be implemented as various kinds of currently available suitable suction nozzle structures. In some embodiments, the suction nozzle 2 includes a nozzle body 21 and a soft rubber part 22. As illustrated in FIG. 2, the nozzle body 21 defines a semi-open cavity, and the open end of the semi-open cavity faces towards the outside of the main body 1. A hole 23 is defined in the nozzle body to communicate the semi-open cavity with the air passage 11. The soft rubber part 22 is fixed at the open end of the nozzle body and is operative to be in direct contact with the product to be sucked up. The elastic member 3 is pressed against between the suction nozzle 2 and the step.

The suction nozzle can be connected to the main body 1 by a variety of suitable structures. For example, the suction nozzle can be connected to the main body through a spring. In this case, the suction nozzle and the air passage 11 can communicate with each other through a bellows sleeved inside the spring. In this disclosure, the suction nozzle is typically connected to the main body 1 through a connecting unit that includes a movable block and a columnar stop pin.

As illustrated in FIG. 2 or 3, the movable block 4 is a hollow barrel which is a cylindrical hollow barrel in this embodiment. A longitudinal closed groove 41 is defined in the side wall of the movable block. By the “closed groove”, it means that the groove is defined in the side wall of the barrel and does not communicate with two end faces of the barrel.

The movable block 4 is fixed to the suction nozzle 2, or the two can also be integrally manufactured. If the suction nozzle and the movable block are combined into a unity, then the closed groove 41 can be defined in the outer side wall of the nozzle body, and the material thereat has a certain degree of hardness and so would not affect the connection with the main body and the airtightness of the suction nozzle.

The movable block 4 is located between the suction nozzle 2 and the elastic member 3 and is in clearance fit with the inner wall of the main body 1. The hole 23 of the nozzle body and the hollow cavity of the movable block communicate with the air passage 11. Thus, when the suction nozzle contacts the product a, the product would seal the semi-open cavity of the nozzle body, and the gas within the cavity can be drawn out of the suction device through the hole 23, the hollow cavity of the movable block, the hole in the center of the elastomer, and the air channel 11 successively. The clearance fit between the movable block and the main body not only ensures that the movable block can move freely within the main body, but it prevents too much air from entering the passage from outside the suction nozzle, thus reducing the pressure loss.

A through hole 15 is defined in the side wall of the main body. The position of the through hole 15 corresponds to the closed groove 41. The stop pin 5 is inserted through the through hole 15 into the closed groove 41, whereby the movable block 4 and the suction nozzle 2 as a whole are connected to the body 1 and movable within a certain range inside the main body. As illustrated in FIG. 2 and FIG. 3, the movable block 4 moves to the right along with the suction nozzle 2 before being blocked by the compressed spring or by the left end of the closed groove 41, or moves to the left before being blocked by the right end of the closed groove.

To ensure the coaxiality between the movable block and suction nozzle as a whole and the inner cavity of the main body enabling the smooth movement of the suction nozzle within the inner cavity of the main body, the above-mentioned connective set consisting of the stop pin and the closed groove and the through hole can be arranged at equal distances in 2 to 4 sets along the circumference of the main body. As an example, three connective sets are arranged; the axis of the passage is taken as the center of the circle and the three connective sets are arranged around the side wall of the main body at intervals of 120 degrees in the plane perpendicular to the axis. Thus, the connection between the evenly distributed three points can render the forces balanced, facilitating the smooth movement of the movable block and the suction nozzle as a whole relative to the main body.

The passageway between the air outlet end and the elastic member is the air passage 11, where a segment of space in the air passage that has a diameter larger than the diameter of the passageway is defined as an air reservoir 16; that is, the air reservoir 16 is located in the passage between the inner cavity and the air outlet of the passage. The air reservoir can provide sufficient air which can extend the time required for the suction process from the suction nozzle contacting the product to the product being sucked up—so sufficient time is allowed for product corrections.

The elastic member 3 is a component that can be contracted in volume when subjected to compression and recovers after removal of the external force. The elastic member 3 can typically be implemented as a polyurethane block. A through hole is defined in the center of the polyurethane block to communicate the hole 23 of the nozzle body with the air passage 11, ensuring the normal operation of the suction nozzle.

The elastic member 3 can also be chosen as a common compression spring such that the hollow part at the center of the spring can communicate the hole of the nozzle body with the passage, which can also ensure the normal operation of the suction nozzle.

In order that the elastic member still settles in its working position without displacement under the natural state free of negative pressure, a first boss 45 is arranged on the contact surface between the movable block 4 and the compression spring. The first boss 45 extends into the center of the compression spring preventing dislocation of the compression spring.

Based on the same concept, a second boss 17 also can be disposed on the abutment surface between the compression spring and the main body. The second boss extends into the center of the compression spring preventing dislocation of the compression spring. Alternatively, both the first boss 45 and the second boss 17 may be arranged.

The material of the soft rubber part in accordance with this disclosure may include silicone, silicone rubber, polyurethane, nitrile rubber, or a vinyl-containing polymer. Compared with existing rubber suction nozzles, the soft rubber part of this disclosure enhances the anti-wear ability, reduces the frequency of production halt and replacement, improves the production efficiency, avoids the generation of a large amount of discarded rubber, and saves energy and protects the environment. In addition, the material of the soft rubber part of the disclosure is softer and so can provide greater amounts of deformation under the same suction force thus providing better sealing effects in relation to the product. The soft rubber part can also reduce the occurrence of product slippage with suction surfaces having a curved profile.

As illustrated in FIG. 3, when the suction device in accordance with the disclosure is used to suck up the product as illustrated in FIGS. 1B or 1C, although the suction area and the abutment area are not in the same plane, the suction area is substantially a plane and the abutment area doesn't undergo a big change. In this case, the suction device of the disclosure is moved to contact the product, and as the pressure within the passage decreases the product would be pressed towards the suction device. The suction nozzle would then compress the elastic member and drive the product to retract inward the main body, until the suction area abuts against the suction nozzle mounting end of the main body—so far the suction action is completed. When the product has a convex surface as illustrated in FIG. 1C—that is, there is a curved surface in the suction area—then the soft rubber part can adopt a congruent design with the profile at the suction surface of the product to be sucked up; in other words, the profile of the end surface of the soft rubber part is in congruence with the undulations of the profile of the suction area.

Note, in sucking up a product having a convex or concave surface using the suction of the present disclosure, the actual contact area between the suction nozzle and the product would deviate from the suction area when the original setting position of the product is slightly changed. During the suction process, due to the height difference between the suction area and the abutment area, the suction nozzle mounting end of the main body contacts the product during the retraction process of the suction nozzle and would create a lateral force serving a guiding function to adjust the dislocated product. Thus, the actual contact area between the suction nozzle and the product will be brought close to the suction area until the two coincide with each other, so that the product can be placed in the specified precise position and multiple products can also be repeatedly placed in their accurate positions, hence precise positioning and repeatable precise positioning. That is, the deviation of the initial position is corrected. At this point, the end surface of the suction nozzle mounting end of the main body lies in the same plane, facilitating the complete fitting with the abutment area.

In some embodiments, when the abutment area also has a slight undulation or camber, the end surface of the suction nozzle mounting end of the main body can also adopt a congruent design with the curved surface (i.e., the abutment area) around the suction surface of the product to be sucked up.

The congruent surface design enables tighter sealing of the suction nozzle in relation with the product, thereby reducing the occurrence of pickup failures caused by leakage of the suction nozzle.

Some illustrative embodiments in accordance with the disclosure have been described by examples in which the air passage 11 is collinear with the inner cavity at the suction nozzle mounting end of the main body. The present disclosure, however, will not be limited thereto; in other embodiments, for example, the air passage 11 may also be disposed at a certain angle or even perpendicular to the inner cavity at the suction nozzle mounting end of the main body, thereby accommodating to some special working conditions.

It will be appreciated that based on the same principle, the suction device provided by this disclosure can also be used to suck up a product with a flat surface as illustrated in FIG. 1A, or even a product having a groove in its surface—in this case, the suction nozzle would protrude from the suction nozzle mounting end of the main body under the natural state absent negative pressure. The suction device with the structure described above can also be used to suck up products having a concave surface, while other structural features will be the same as those of the suction device used to suck up products having a convex surface; see the foregoing description for details.

To accommodate to different working conditions, the suction nozzle of the suction device in accordance with this disclosure can protrude from the suction nozzle mounting end of the main body, or may retract into the suction nozzle mounting end of the main body, as long as the suction nozzle can be brought into contact with the suction area prior to the suction nozzle mounting end contacting the abutment area. In some embodiments, when used to suck up a product having a concave surface, the protruding length needs to be made greater than the height difference between the suction area and the abutment area, so that the suction nozzle can contact the concave surface and the margin required for the suction nozzle to retract into the main body can also be provided.

In various embodiments, to effectively adjust the position of the product when deviation occurs in using the suction device of the disclosure, the vacuum is generated within the suction nozzle after the end surface of the suction nozzle mounting end of the main body abuts against the abutment area, thus preventing the suction nozzle from interfering with the deviation adjusting process. This disclosure not only solves the suction problems in sucking up thin products having a curved surface, but it is applicable to non-thin products.

The suction device provided by the present disclosure has been described in detail in the foregoing. Specific examples are raised herein for purposes of illustrating the principle and implementations according to the disclosure. The foregoing description of embodiments is intended to merely facilitate understanding of methods and central ideas in accordance with disclosure. Meanwhile, those having ordinary skill in the art will be able to make modifications to the specific implementations and their application scope based on the concept of the present disclosure. Therefore, the foregoing description should not be construed in a limiting sense.

What is claimed is:

1. A suction device, comprising:
a main body, wherein a through passage is defined in the main body, one end of the main body is defined as a suction nozzle mounting end, and the part of the through passage at the suction nozzle mounting end is defined as an inner cavity;
a suction nozzle, movably installed within the inner cavity and connected to the main body and communicated with the through passage; and
an elastic member, disposed within the inner cavity and operative to provide a pushing force for moving the suction nozzle outward of the inner cavity.

2. The suction device of claim 1, wherein the suction nozzle is connected to the main body through a connecting unit, the connecting unit comprising:
a movable block which is a hollow barrel; wherein a closed groove is defined in a side wall of the movable block, and wherein the movable block is fixed to the suction nozzle and disposed between the suction nozzle and the elastic member, and is in clearance fit with an inner wall of the inner cavity, and is operative to move along with the suction nozzle within the inner cavity; and
a columnar stop pin; wherein a through hole is defined in the side wall of the main body, and the columnar stop pin is inserted through the through hole into the closed groove and is operative to move within the closed groove to prevent the suction nozzle from detaching from the main body when the movable block is moved within the inner cavity.

3. The suction device of claim 2, wherein one corresponding columnar stop pin, one corresponding closed groove, and one corresponding through hole constitute one connective set, and two to three such connective sets are arranged at equal distances along a circumference of a cross section of the main body.

4. The suction device of claim 1, further comprising an air reservoir which is a part of the through passage located between an air inlet end of the through passage and the inner cavity, the air reservoir having a diameter greater than that of the through passage.

5. The suction device of claim 1, wherein the suction nozzle comprises a nozzle body and a soft rubber part, and wherein the nozzle body defines a semi-open cavity having an open end facing the outside of the main body, and a hole is defined in the nozzle body to communicate the semi-open cavity with the through passage; and the soft rubber part is fixed at the open end of the nozzle body.

6. The suction device of claim 5, wherein the surface of the soft rubber part has a congruent design with the profile of a suction surface of a product to be sucked up.

7. The suction device of claim 1, wherein the suction nozzle protrudes from the suction nozzle mounting end of the main body.

8. The suction device of claim 1, wherein the elastic member is a polyurethane block, and a through hole is defined in the center of the polyurethane block to communicate the suction nozzle with the through passage.

9. The suction device of claim 2, wherein the elastic member is a compression spring.

10. The suction device of claim 1, wherein an end surface of the suction nozzle mounting end of the main body lies in the same plane.

11. The suction device of claim 5, wherein the soft rubber part is made of at least one selected from the group consisting of silicone, silicone rubber, polyurethane, nitrile rubber, and a vinyl-containing polymer.

12. The suction device of claim 1, wherein the suction nozzle retracts into the interior of the suction nozzle mounting end of the main body.

13. The suction device of claim 9, wherein a first boss is disposed on a contact surface between the movable block and the compression spring, and wherein the first boss extends into the center of the compression spring and is operative to prevent dislocation of the compression spring.

14. The suction device of claim 9, wherein a second boss is disposed on an abutment surface between the compression spring and the main body, and wherein the second boss extends into the center of the compression spring and is operative to prevent dislocation of the compression spring.

15. The suction device of claim 9, wherein a first boss is disposed on a contact surface between the movable block and the compression spring, and wherein the first boss extends into the center of the compression spring and is operative to prevent dislocation of the compression spring; and a second boss is disposed on an abutment surface between the compression spring and the main body, and wherein the second boss extends into the center of the compression spring and is operative to prevent dislocation of the compression spring.

16. The suction device of claim 1, wherein an end surface of the suction nozzle mounting end of the main body has a congruent design with the profile surrounding a suction surface of a product to be sucked up.

17. The suction device of claim 6, wherein an end surface of the suction nozzle mounting end of the main body has a congruent design with the profile surrounding a suction surface of the product to be sucked up.

18. The suction device of claim 1, wherein the through passage is collinear with the inner cavity at the suction nozzle mounting end of the main body.

19. The suction device of claim 1, wherein the through passage is disposed at an angle to inner cavity at the suction nozzle mounting end of the main body.

20. The suction device of claim 19, wherein the angle is a right angle.
